(19) United States
(12) Patent Application Publication
(10) Pub. No.: US 2004/0061305 A1
(43) Pub. Date: Apr. 1, 2004

(54) Rear wheel suspension system for a bicycle

(76) Inventor: Steven J. Christini, Philadelphia, PA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/673,284

(22) Filed: Sep. 30, 2003

Related U.S. Application Data
(60) Provisional application No. 60/414,397, filed on Sep. 30, 2002.

(51) Int. Cl. B62K 25/00

(52) U.S. Cl. 280/284

(57) ABSTRACT

The present invention is a “three bar” rear wheel suspension system with increased lateral stiffness and reduced tendency for pedal induced bobbing. The rear wheel suspension system of the present invention features a rigid one-piece rear frame section and a short link that are attached with the front frame section at three pivot points. Movement of rear frame section along an arc defined by the length of the short link rather than along the arc that defines by the distance between the bottom yoke pivot point and the top yoke pivot point causes the rear frame section to flex. Active flexing of the rear frame section as it moves through its suspension range absorbs additional energy from the movement of the rear wheel resulting in an “active arc” second suspension system.

### CROSS-REFERENCE TO RELATED APPLICATIONS

This application claims the benefit under 35 U.S.C. 119(e) of Provisional Application Serial No. 60/414,397, entitled “Rear Wheel Suspension System for a Bicycle,” and filed on Sep. 30, 2002, which is incorporated herein by reference in its entirety.

### BACKGROUND OF THE INVENTION

1. Field of the Invention

The invention relates to a rear wheel suspension system for a bicycle that provides both extreme lateral stiffness preventing side-to-side sway and torsional flex of the rear frame section and rear wheel of the bicycle as well as significantly reducing pedal-induced “bobbing” or bounce that results as a reaction to the downward force placed on the pedals by the rider.

2. Related Art

As off road biking has gained broader appeal, the demands that riders place on their bicycles have increased dramatically. Cross-country, downhill, adventure, and endurance racers and recreational riders have increasingly demanded rear wheel suspension on their bicycles, generally a system that incorporates a shock absorber and rear wheel pivot design into the bicycle frame to allow the rear wheel to move independently of the front portion of the frame in order to absorb much of the impact forces experienced as the bicycle hits numerous bumps, particularly on an off-road trail. The growth of rear wheel suspension on bicycles has been dramatic over the past ten years for two primary reasons: 1) Rear suspension systems increase comfort since the rear wheel suspension provides a smoother ride since much of the jarring forces from bumps are absorbed and not transmitted to the rider's seat, and 2) rear suspension systems increase traction and control since the rebound of the rear wheel suspension acts to keep the rear wheel in better contact with the trail surface after hitting a bump.

The concept of a rear wheel suspension bicycle is known. In general, such bicycles feature a rigid front frame section which includes the head tube to which the front wheel and steering system are attached and a seat tube on which the seat is mounted. The front frame section also usually includes the bottom bracket which is the location on the frame where the pedals are mounted. As is apparent from the name, the rear wheel of a rear wheel suspension bicycle is suspended relative to the front frame section to enable the rear wheel to move independently of the front frame portion, and importantly, the seat and rider.

The rear wheel suspension generally includes a pair of chainstays that run approximately parallel to the riding surface and connect the rear axle and rear wheel via dropouts to the bottom bracket. Due to the typically small and light dimensions of the chainstays, additional rear frame members commonly know as seatstays usually attach at the dropouts, pass along each side of the wheel and connect to the front frame section at the seat tube above the bottom bracket to provide support and rigidity to prevent the chainstays from bending under the force of riding. Innumerable pivot combinations at the bottom bracket, dropouts, and seat post connections allow rear wheel movement along an arc defined by one of the pivot points and thus, independent movement of the rear frame section and rear wheel relative to the front frame section. Finally, a rear wheel suspension shock is integrated into the system to provide the shock-absorption and rebound response necessary for the system to function.

Importantly, rear wheel suspension bicycles, while desirable from a rider's comfort and performance perspective, generally include at least three significant drawbacks. First, pedal induced “bobbing” results from the upward force the chain places on the wheel during the pedal downstroke that results in a slight movement of the rear wheel by compressing the rear shock. When the tension on the chain is released, the shock then expands and forces the rear wheel back to its original position. Through this cycle, a rider using aggressive pedaling forces creates a pronounced bounce during the bicycle ride.

Second, while completely rigid bicycle frames that attach the rear wheel to the frame without any pivot points are, as expected, extremely rigid both vertically and laterally, rear wheel suspension bicycles have decreased vertical as well as lateral stiffness owing to several factors. These factors include the size of the frame tubing and attachment points, the number and location of the pivot points, and the size and attachment point of the rear shock, among others. Furthermore, while vertical stiffness of the rear wheel suspension system resulting from pedal-induced bobbing can be addressed through pivot locations and number as well as rear shock technology (damping, etc.) lateral or horizontal stiffness is a factor of frame component size and the number of pivot points. Further, since weight reduction is critical in bicycle design and manufacture, adding significant weight to a bicycle frame to enhance lateral stiffness is not a feasible scenario.

Third, the vertical movement of the rear wheel or “travel” is often limited due to rear shock technology and frame design and weight limitations. The current trend of three to four vertical inches of rear wheel “travel” as it swings on an arc relative to the bottom bracket is limited by the weight that must be added to the rear shock to accommodate such movement. Furthermore, most spring or air shocks do not feature equal resistance through the entire compression distance and thus, the first couple of inches of rear wheel movement generally occur with less resistance. Such a configuration is then also susceptible to pedal-induced bobbing.

Ultimately, the balance between positioning and number of pivot points, the rear shock location and the size of chainstays and seatstays, and the desired rear wheel travel distance have become critical to frame design and overall rear wheel suspension performance. A heavy rear wheel suspension system is not commercially viable, and a lighter rear wheel suspension system may be both laterally flexible as well as producing unacceptable levels of pedal-induced bobbing. Finally, a system which features four or more rear wheel suspension pivot points to reduce pedal-induced bobbing may eventually suffer from reduced lateral stiffness as bushing and bearing tolerances loosen through normal wear-and tear.

Several rear wheel suspension systems have been patented seeking to improve upon these fundamental concepts of improving lateral stiffness and reducing pedal-induced bobbing as well as increasing the overall performance and responsiveness of the rear wheel suspension system: U.S. Pat. No. 4,789,174 (Lawwill) illustrates a rear wheel suspension system with a series of pivotable attachments at the bottom bracket and additional pivot points at the rear dropouts and mid-way along the seat tube. A large spring shock absorber attaches to the chainstays near the bottom bracket and along the seat tube.

U.S. Pat. Nos. 5,678,837 (Leitner) and 5,409,249 (Busby) illustrate similar configurations that are now popular on several rear wheel suspension mountain bikes. Chainstays are pivotally attached near the bottom bracket of the seat tube at the front ends and to the seatstays at the rear ends. The upper end of the seatstays are pivotally attached to a short linkage section which is pivotally attached at its other end near the upper end of the seat tube. Such a “four-bar linkage” system includes four rigid sections and four pivot points and provides a responsive suspension system with some reduction in pedal-induced bobbing.

U.S. Pat. No. 6,164,676 (Wilcox) illustrates a modified four-bar linkage with four pivot points comprising a large rear swingarm as the chainstay that attaches to the front frame section near the bottom bracket. Two short linkages pivotally attach each other and then attach the front frame section and swingarm.

U.S. Pat. No. 6,386,568 (Tribotte) shows another variation of a rear wheel suspension system with four pivot points and linkage bars resulting in a rear wheel suspension systems described as an articulated quadrilateral.

U.S. Pat. No. 6,406,048 (Castellano) shows a rear wheel suspension system bicycle that reduces the number of pivot points necessary, thereby decreasing the weight and complexity of the system and increasing lateral and torsional rigidity. The patent discloses the use of flexible chainstays that eliminate the need for pivot points at the bottom bracket and rear dropouts with pivot points needed only at the ends of the rear shock. Thus, to absorb bumps, the flexible chainstays bend in a manner that forces the seat stays up and compress the rear shock. However, due to flex limitations of current metal alloy technologies, the flexible chainstays, and thus the entire rear wheel suspension system is limited in movement of 1-2 inches. This technology, therefore, has limited application for rear wheel suspension systems that are now trending to four inches or more of rear wheel vertical movement.

It is, therefore, an object of this invention to provide a rear wheel suspension system that is laterally rigid and reduces pedal-induced bobbing.

It is a further object of this invention to provide a rear wheel suspension system that includes three or less pivot points yet accommodates long-travel rear wheel suspension of four to six inches or more.

It is a further object of this invention to provide a rear wheel suspension system that utilizes pivot and shock locations as well as a linkage system that provides superior resistance against pedal-induced bobbing.

Other objects and advantages will be more fully apparent from the following disclosure and appended claims.

### SUMMARY OF THE INVENTION

The present invention is a rear wheel suspension system for a bicycle that includes a front frame section and a rear wheel suspension section. The front frame section incorporates the traditional aspects of a bicycle frame including the head tube to attach the handlebars and front fork and front wheel, a top tube, a seat tube into which the seat is mounted, a down tube connected to the head tube at one end and a bottom bracket at the other end. The seat tube connects one end of the top tube with the other side of the bottom bracket thus forming a front frame section that is roughly triangular in configuration.

The rear wheel suspension section of the present invention includes a rigid rear frame section that pivotally attaches at its front end to both sides of the bottom bracket and at its upper end to a short frame linkage section. The rear frame section can further include a bottom yoke that attaches the front ends of a right chainstay and a left chainstay, right and left dropouts rigidly attached to the rear end of the right and left chainstays, a pair of seat stays rigidly attached at one end to the right and left dropouts, and at the other end to a top yoke.

The chainstays and seatstays in the present invention can be rigidly attached to the respective dropouts at an angle of less than 90 degrees to enable pivotable attachment of the lower yoke at the bottom bracket and the upper yoke to a short link that, in turn, can pivotally attach to the seat tube. Thus, as viewed from the side, the rear frame section forms an approximate sideways “V” shape and, as viewed from the top, the connection of the chainstays to the bottom yoke and the seatstays to the top yoke form an approximate “U” shape with the dropouts forming the open end of the “U”. The axle of the rear wheel of the bicycle is rotatably attached between the dropouts as is well known in the art.

Significantly, the present invention, as distinguished from other rear suspension designs described above, need not include any pivot points at or near the rear dropouts and thus could be properly described as a “three bar” suspension system with the rear frame section, the short link and the seat tube comprising the three rigid, yet pivotally connected “bars.”

In fact, the reduction of the pivot points from four to three produces a rear frame section of exceptional lateral stiffness and, therefore, is resistant to torsional and lateral movement and flex while riding. The one-piece top yoke can attach each upper end of the seat stays with the one-piece short link on each side of the seat tube. Similarly, the one-piece bottom yoke can attach each front end of the chainstays to each side of the bottom bracket. Finally, the top yoke section can pivotally attach to the short link on both sides of the seat tube which in turn is pivotally attached to the front side of the seat tube. In the present invention, the one-piece configuration of the top yoke, the bottom yoke, and the short link further add to the stiffness of the rear frame section. Specifically, the short link, with its pivotable attachments to the top yoke and the seat tube, provides stiffness to the seat stays and top yoke of the rear frame section while the bottom yoke, made of a single piece of metal in the present embodiment provides optimal stiffness for the chainstays and rear wheel.

A rear shock, pivotally attached at one end to the top tube and at the other end to the front end of top yoke, forward of the pivotable attachment of the top yoke and short link, is compressed in the present configuration by upward movement of the rear wheel. As the rear wheel moves upward, the rear frame section moves forward as a single unit around the short link arc, the radius of which is the distance between the seat post pivot point where and the top yoke pivot point where the top yoke attaches the short link. Thus, in the illustrated embodiment, as the rear frame section moves forward along the short link arc, the top yoke, which is forked, moves forward along each side of the seat tube and compresses the rear shock.

A feature of the illustrated embodiment, is that the length of the short link arc is different from the length of the distance between the top yoke pivot point and the bottom yoke pivot point, which is the path that the rear frame section would naturally follow. Thus, to move along the short link arc the rear frame section flexes minimally to accommodate the short link arc radius due to the fact that the length of the short link, which defines the radius of short link arc, is extremely rigid. Thus, in the illustrated embodiment, forward movement of the rear frame section along the short link arc causes an approximate 2-4 mm flex or change in the distance of the upper yoke pivot point relative to the bottom bracket pivot point as the rear frame section moves. The distance of flex of the present invention, however, should not be construed as limiting the present invention as any distance of flex is anticipated in the current design.

Additionally, flexing the rear frame section by the approximate 1-2 mm as it swings from a point inside the short link arc to a point outside the short link arc and finally back to a point 1-2 mm inside the short link arc, utilizes energy that would otherwise be transmitted to the rear shock. In fact, the flexing of the rear frame section acts much in the same way as compressing the air or coil shock. The active flexing of the rear frame section to accommodate the path of the short link arc requires energy which acts to slow the movement of the rear wheel in an upward direction. This feature of the present invention, so called “active-arc” suspension, because of the flexing of the rear frame section requires additional energy and acts as a second rear shock section as it swings along the path defined by the short link arc, in fact, also reduces the pedal-induced bobbing. Finally, the expansion distance of the rigid rear frame section is less than the fatigue point of the aluminum metal of which it is made. This fact ensures that the rear frame section is can flex hundreds of thousands of times over the life of the bicycle frame without fatigue or failure.

Thus, according to the broad aspects of the invention, the “three bar” rear wheel suspension system may comprise:

(a) an extremely rigid rear suspension system with reduced pedal-induced bobbing that features a rigid one-piece rear frame section pivotally attached to both sides of the bottom bracket and to a short link that is pivotally attached at each end to the rear frame section and then to the seat tube to form the present invention's “three-bar” suspension configuration;

(b) a rear shock attached to the front frame section and to the rear frame section in order to expand and contract with the movement of the rear wheel to allow for movement of the rear frame section independent from the front frame section;

(c) a short link rotatably attached to the seat tube and the rear frame section so that movement of rear frame section is dictated to be along an arc defined by the movement of the short link along its rotational arc rather than along the arc that defined by the distance between the bottom yoke pivot point and the top yoke pivot point, and thus, requires the rear frame section to expand a distance of 2-4 mm as it travels through the short link arc;

(d) top yoke, bottom yoke and short link pieces made of a single piece of machined, cast, forged or welded metal that attach both ends of the rigid seatstays and chainstays respectively; and

(e) three pivot points, for the “three-bar” suspension system, at the bottom yoke, top yoke and seat post.

### BRIEF DESCRIPTION OF THE DRAWINGS

FIG. 1 is a side view of the front frame section of the rear wheel suspension bicycle embodying the principles of the present invention.

FIG. 2 is a side view of the rear frame section of the rear wheel suspension bicycle embodying the principles of the present invention.

FIG. 3 is a side view of the rear wheel suspension system in the fully extended configuration.

FIG. 4 is a side view of the rear wheel suspension system in the fully compressed configuration.

FIG. 5 is a close up view of the short link, top yoke and respective concentric arcs showing the overlap of the rear frame section arc as compared to the short link arc.

FIG. 6 is a bottom view of the rear frame section.

FIG. 7 is a front view of the short link.

FIG. 8 is a top view of the rear frame section.

### DETAILED DESCRIPTION

As shown in FIGS. 1, 2, and 3, the present invention includes a rear wheel suspension system for a bicycle that includes a front frame section 1 and a rear frame section 2. The front frame section incorporates the traditional aspects of a bicycle frame including the head tube 3 to attach the handlebars (not shown) and front fork (not shown) and front wheel (not shown), a top tube 4, a seat tube 5 into which the seat (not shown) is mounted, a down tube 6 connected to the head tube 3 at one end and a bottom bracket 7 at the other end. The seat tube 5 connects with the rear end of the top tube 4 with and at its lower end with the bottom bracket 7 thus forming a front frame section 1 that is roughly triangular in configuration.

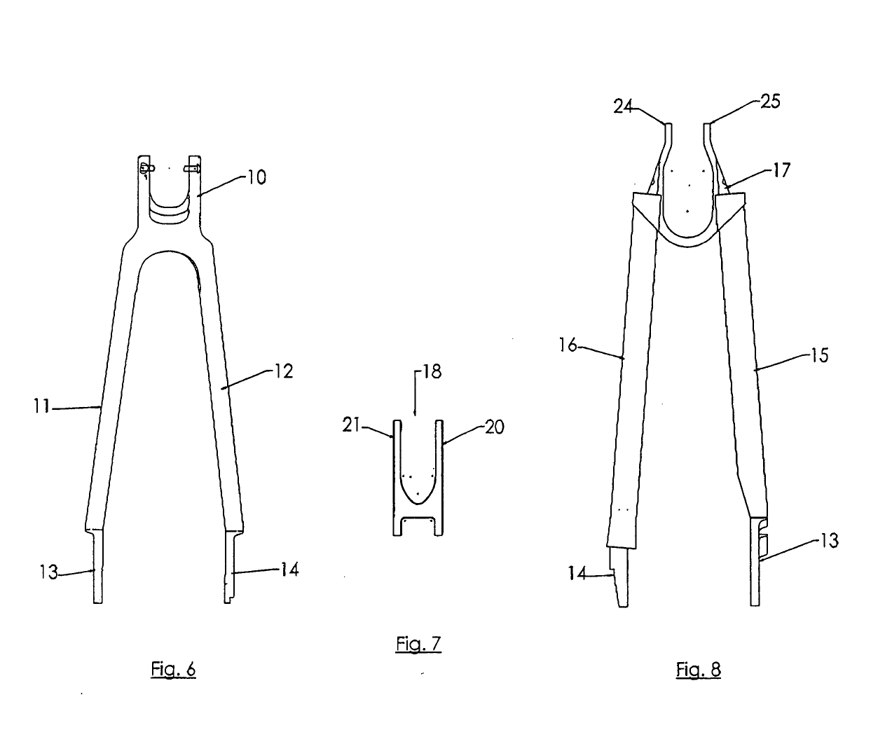

The rigid rear frame section 2 pivotally attaches to both sides of the bottom bracket 7 and with the seat tube 5 through a short link 18. As best seen in FIGS. 6-8, the rear frame section 2 further includes a bottom yoke 10 that attaches a right chainstay 11 and a left chainstay 12. A right dropout 13 and a left dropout 14 rigidly attach to the rear end of each of the right chainstay 11 and the left chainstay 12 respectively. A right seat stay 15 and a left seat stay 16 rigidly attach at their lower ends to a right dropout 13 and a left dropout 14 respectively. The right seatstay 15 and the left seat stay 16 attach at each upper end to a single top yoke 17.

The chainstays 11, 12 and seatstays 15, 16 in the present invention can be rigidly attached to the respective dropouts 13, 14 at an angle of less than 90 degrees. The rear frame section 2 is configured to attach to the front frame section 1 at a bottom yoke pivot point 22 where the bottom yoke 10 pivotally attaches the bottom bracket 7. The top yoke 17 of the rear frame section 2 can pivotally attach to a right short link arm 20 and left short link arm 21 of the short link 18 at a top yoke pivot point 19. To complete the attachment to the front frame section 1, the short link 18 can pivotally attach to the seat tube 5 at the seat tube pivot point 23.

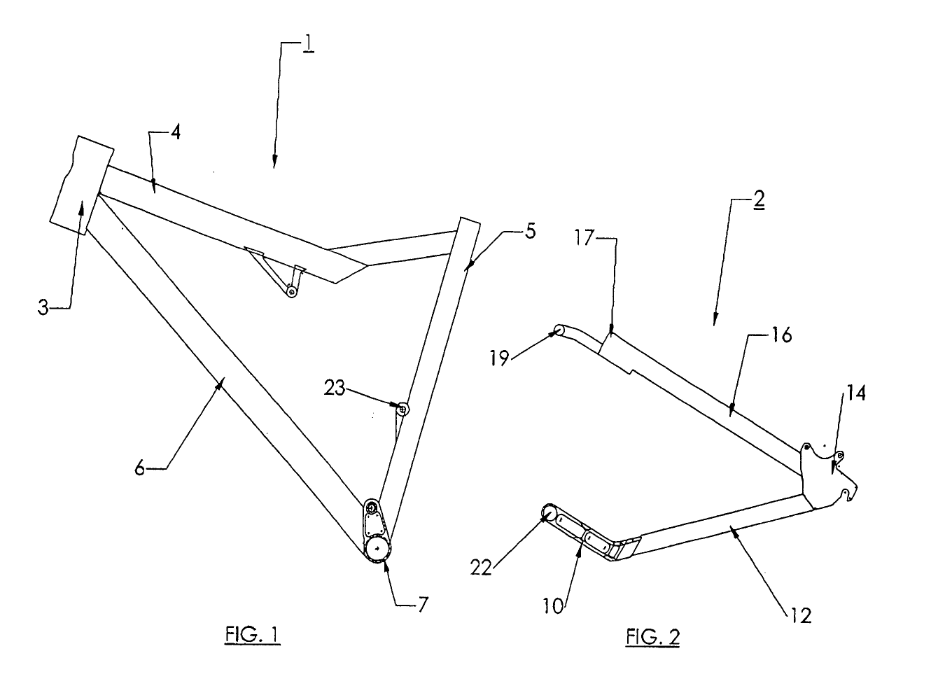

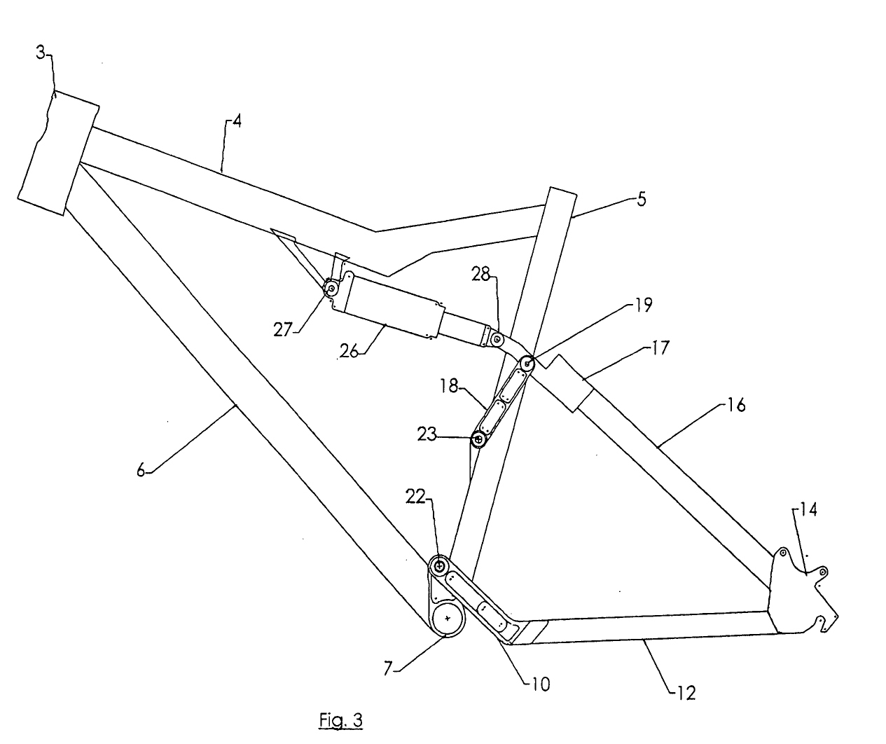

As shown in FIG. 1, the rear frame section 2 forms an approximate sideways “V” shape. As shown in FIGS. 6 and 8, the attachment of the chainstays 11, 12 to the bottom yoke 10 and the seatstays 15, 16 to the top yoke 17 form an approximate “U” shape with the dropouts 13, 14 forming the open end of the “U”. The axle of the rear wheel (not shown) of the rear wheel suspension bicycle is rotatably attached between the dropouts 13, 14 as is well known in the art. Thus, as shown in FIGS. 2, 3, and 4, the present invention, as distinguished from other rear suspension designs, does not include any pivot points at or near the rear dropouts 13, 14 and thus could be properly described as a “three bar” suspension system with rigid rear frame section 2 pivotally attached at the top yoke pivot point 19 with the short link 18 and at the bottom yoke pivot point 22 to either side of the bottom bracket 7. Finally, the short link 18 is pivotally attached to the seat tube 5 at the seat tube pivot point 23. Thus, the rear frame section 2, short link 18, and seat tube 5 comprise the three rigid, yet pivotally connected “bars” in the illustrated embodiment of the bicycle rear suspension system.

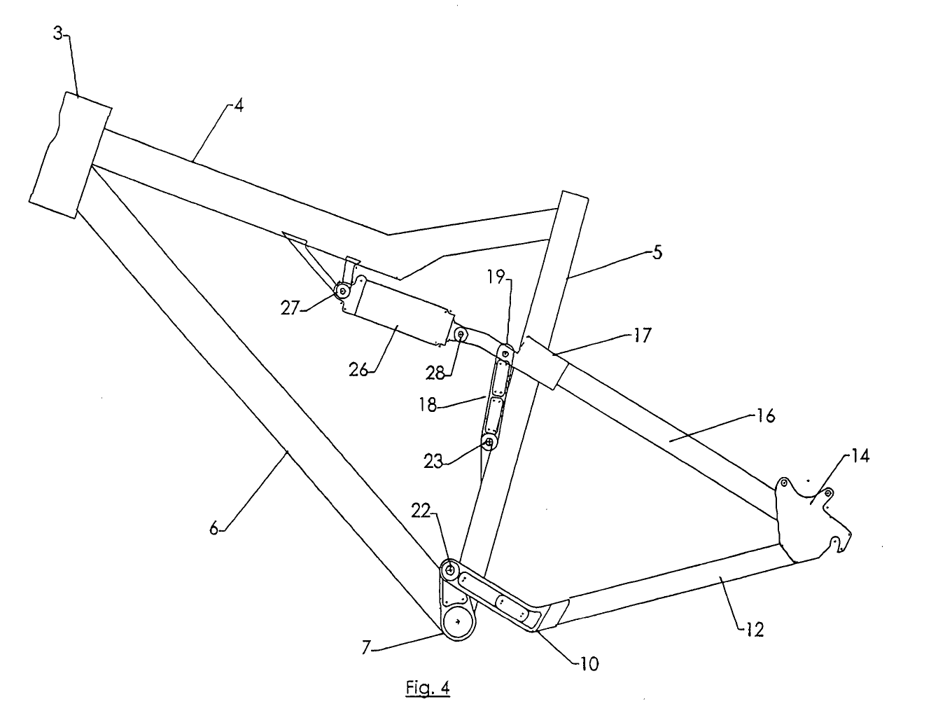

In an additional feature of the embodiment illustrated in FIGS. 3, 4, and 8, the top yoke 17 includes a pair of forked ends 24, 25 that pass along both sides of the seat tube 5 and each of the forked ends 24, 25 which are configured to pivotally attach to a rear shock 26. In the illustrated embodiment, the rear shock 26 includes a front shock end 27 pivotally attached to the top tube 4 and a rear shock end 28 pivotally attached to the forked ends 24, 25 of the top yoke 17. The pivotable attachment of the rear shock 26 with the top tube 4 and top yoke 17 allow movement of the rear wheel bicycle suspension system through compression of the rear shock 26 as is well known in the art. As shown in FIGS. 3 and 4, in the present embodiment, the rear wheel (not shown) may move, for example, as much as four inches vertically when the rear shock 26 compresses. However, the distance of “travel” of the rear wheel shall not be construed as limiting the current invention as greater distances could certainly be configured merely by changing the dimensions of the rear frame section 2 and increasing the compression distance of the rear shock 26.

In the illustrated embodiment, as shown in FIGS. 6, 7, and 8, each of the top yoke 17, bottom yoke 10, and short link 18 can be made of one piece of machined metal which results in a rigid rear frame section 2 of exceptional stiffness which is highly resistant to lateral and torsional forces. Other one-piece configurations could be used including welded, cast or forged parts. Moreover, as discussed above, the presence of only three pivot points in the “3 bar” suspension system, namely the top yoke pivot point 19, the bottom yoke pivot point 22, and the seat tube pivot point 23 provides further stiffness. Moreover, the fact that the bottom yoke 10 pivotally attaches at each side of the bottom bracket 7, the forked ends 24, 25 of the top yoke 17 pivotally attach to each of the left short link arm 21 and right short link arm 20 respectively on each side of the seat tube 5, and the short link 18 pivotally attaches to each side of the seat tube pivot point 23 provides dual point attachments at each pivot point 19, 22, and 23, respectively, providing further lateral stiffness to the rear wheel bicycle suspension system.

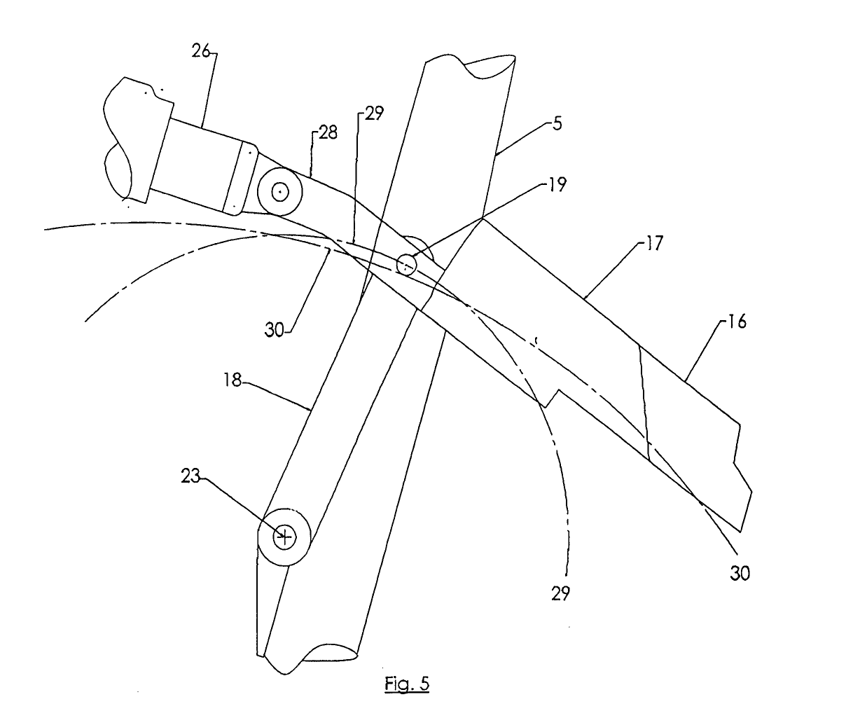

As illustrated in FIGS. 3 and 5, when the rear wheel suspension system is fully extended, the top yoke pivot point 19 is located slightly behind the seat tube 5. As shown in FIGS. 3, 4 and 5, upward movement of the rear tire (not shown) and rear dropouts 13, 14 result in causing the rear frame section 2 to rotate around a short link arc 30 with the distance between the seat tube pivot point 23 and the top yoke pivot point 19 defining the radius of the short link arc 29. Additionally, as shown in FIGS. 3, 4, and 5, movement of the rear frame section 2 and top yoke pivot point 19 during compression of the rear shock 26 is actually forced by the attachment of the short link 18 to the top yoke pivot point 19 and seat tube pivot point 23 to track on the short link arc 29 rather than along the path of a rear frame arc 30 which radius is defined by the distance between the bottom yoke pivot point 22 and the top yoke pivot point 19. Thus, as shown at FIG. 5, as the rear frame section 2 moves forward relative to the front frame section 1, the short link arc 29 and rear frame arc 30 cross twice causing the rear frame section 2 to flex as it moves through its rotation along the short link arc 29 around the seat tube pivot point 23 rather than along the rear frame arc 30 which is centered on the bottom yoke pivot point 22.

More specifically, in the illustrated embodiment as illustrated by FIGS. 2, 3, and 4, as the rear shock 26 is compressed, the top yoke pivot point 19 of the rear frame section 2 can rotate along the short link arc 29 from a position that originates approximately 1-2 mm inside the path of the rear frame arc 30 to a position mid-way through the rear shock 26 compression that is approximately 1-2 mm outside the rear frame arc 30 and finally to a position when the rear shock 26 is fully compressed that is approximately 1-2 mm inside the rear frame arc 30.

Thus, by forcing the rear frame section 2 to rotate along the short link arc 29, the rear frame section 2 flexes and thus, the rear wheel bicycle suspension system does not require a fourth pivot point at the rear dropouts 13, 14 as is common in other rear suspension designs. Furthermore, the dimensions and distance of the flex of the rear frame section 2 should not be construed as limiting as any amount of frame flex is contemplated provided the fatigue limits of the metal in the chainstays 11, 12, dropouts 13, 14, and seatstays 15, 16 is not exceeded resulting in failure of the rear frame section 2 due to metal fatigue. The expansion and contraction distance of the rigid rear frame section 2 should only be less than the fatigue point of the aluminum metal of which it is made. This fact ensures that the rear frame section is can flex hundreds of thousands of times over the life of the bicycle frame without fatigue or failure. It will be appreciated that other materials can be utilized to manufacture the elements of the present invention.

A further feature of the illustrated embodiment is that the flexing of the rear frame section 2 as it rotates along the short link arc 29 requires energy. Such energy comes from the movement of the rear wheel (not shown) that would otherwise be transmitted to the rear shock 26 and thus, the flexing rear frame section 2 acts as an additional rear shock absorbing feature of the rear wheel suspension bicycle. In fact, the active flexing of the rear frame section 2 along the short link arc 29 requires energy which acts to slow the movement of the rear wheel (not shown) upward. This feature of the illustrated embodiment, so called “active-arc” suspension, because of the expansion of the rear frame section 2 requires additional energy and acts as an additional suspension mechanism as the top yoke pivot point 19 it swings around the short link arc 29, in fact, also reduces the pedal-induced bobbing often experienced when riding rear suspension bicycles.

While the foregoing is directed to the illustrated embodiment of the present invention, other and further embodiments of the invention may be devised without departing from the basic scope thereof, which scope is determined by the claims that follow.

We claim:

1. A rear suspension system for a bicycle, comprising:
a front frame section including a seat tube and a bottom bracket;
said seat tube defining a pivot point and said bottom bracket defining a second pivot point;
a short suspension link including at least two suspension link pivot points, one of said at least two suspension link pivot points configured to pivotally attach to the pivot point on the seat tube;
a rear frame section including at least two rear frame pivot points, one of said rear frame pivot points pivotally configured to attach to the pivot point at the bottom bracket and the other of the rear frame pivot points configured to pivotally attach the other suspension link pivot points;
wherein positioning of each of said pivot points at the bottom bracket, the seat tube, and the short link wherein rotation of the rear frame section around the pivot point at the seat tube causes flexing of the rear frame section.
